(19) United States
(12) Patent Application Publication
(10) Pub. No.: US 2022/0213386 A1
(43) Pub. Date: Jul. 7, 2022

(54) AN INTEGRATED METHOD OF PYROLYSIS CARBONIZATION AND CATALYSIS FOR BIOMASS AND A DEVICE THEREOF

(71) Applicant: INSTITUTE OF ENVIRONMENT AND SUSTAINABLE DEVELOPMENT IN AGRICULTURE, CAAS, Beijing (CN)

(72) Inventors: Zonglu YAO, Beijing (CN); Lixin ZHAO, Beijing (CN); Jixiu JIA, Beijing (CN); Lili HUO, Beijing (CN); Xiaowen HAO, Beijing (CN); Hongbin CONG, Beijing (CN)

(21) Appl. No.: 17/429,402

(22) PCT Filed: Sep. 22, 2020
(86) PCT No.: PCT/CN2020/116634

§ 371 Date: Aug. 9, 2021

(30) Foreign Application Priority Data
Mar. 9, 2020 (CN) 202010157657.4

(51) Int. Cl. C10B 57/12; C10B 53/02; C10B 57/10; C10B 47/30; B01J 6/00; B01J 23/755; B01J 21/18; B01J 37/04; B01J 37/00; B01J 37/06; B01J 37/08; B01J 37/02; B01J 35/10

(52) U.S. Cl. CPC C10B 57/12; C10B 53/02; C10B 57/10; C10B 47/30; B01J 6/008; B01J 23/755; B01J 35/1004; B01J 37/04; B01J 37/009; B01J 37/06; B01J 37/08; B01J 37/0207; B01J 21/18

(57) ABSTRACT

The invention provides a method of pyrolysis carbonization and catalysis for biomass, which comprises: using waste biomass from agriculture and forestry as raw materials, conducting pyrolysis carbonization reaction at 630˜720° C. under oxygen-limited or oxygen-insulation conditions, obtaining biochar and bio-tar-containing pyrolysis oil-gas mixture after gas-solid separation of the products; treating the bio-tar-containing pyrolysis oil-gas mixture obtained with a biochar catalyst at 690˜850° C., carrying out bio-tar catalytic cracking to obtain small molecular combustible gas and light bio-tar, preserving heat and ageing the biochar obtained at 530˜650° C. then making a kind of biochar catalyst. The invention further provides an integrated device used for the method of pyrolysis carbonization and catalysis for biomass, comprising: a spiral feeder, a pyrolysis carbonization device and a catalysis device. The method of pyrolysis carbonization and catalysis for biomass and the device thereof according to the invention can solve the problems presented in the existing methods such as high energy consumption, high cost, and low utilization ratio of energy.

### TECHNICAL FIELD OF THE INVENTION

The invention belongs to the field of pyrolysis for biomass, and specifically relates to a method of pyrolysis carbonization and catalysis for biomass and a device thereof.

### DESCRIPTION OF THE PRIOR ART

As biomass pyrolysis and catalyst regeneration are generally carried out separately, they bring about such a problem as high energy consumption. External heat sources are required to supply heat by both the carbonization furnace and the catalysis chamber in the pyrolysis device. At present, the carbonization furnace is generally separated from the bio-tar catalysis chamber in the pyrolysis device, structurally, so both processes for pyrolysis and catalysis are carried out separately, and the external heat sources of the carbonization furnace and the catalytic chamber are divided to independently supply heat. The catalysis chamber is mostly heated by an electric heating device as an external heat source, or entered by an original pyrolysis gas after it is heated by a preheating furnace. This system structure has high energy consumption, high cost, and low energy efficiency.

The main factor to affect the effect of catalytic cracking is selection for a catalyst. At present, the type of catalysts most commonly used and mostly mentioned in the literature mainly includes natural ore catalysts and precious metal catalysts. However, Precious metal catalysts such as nickel-based catalysts will quickly deactivate due to the presence of sulfur and bio-tar, and are expensive. Ore catalysts such as calcined dolomite and limestone have low mechanical strength, low lifetime and poor thermal stability. Olivine and iron-based catalysts require higher calcination temperature.

In view of the above background, it is necessary to develop a new method of pyrolysis carbonization and catalysis for biomass and a device thereof so as to reduce energy consumption, improve utilization ratio of energy and industrial applicability.

### SUMMARY OF THE INVENTION

The object of the invention is to provide an integrated method of pyrolysis carbonization and catalysis for biomass and a device thereof so as to solve the problems presented in the existing methods such as high energy consumption, high cost, and low utilization ratio of energy.

The technical solution of the invention is as follows:

An integrated method of pyrolysis carbonization and catalysis for biomass firstly provided that includes the following steps:

S1 using waste biomass from agriculture and forestry as raw materials, conducting pyrolysis carbonization reaction at 630˜720° C. under oxygen-limited or oxygen-insulation conditions, obtaining a bio-tar-containing pyrolysis oil-gas mixture and biochar after gas-solid separation of the products,

S2 treating the bio-tar-containing pyrolysis oil-gas mixture obtained from S1 with a biochar catalyst at 690˜850° C., carrying out bio-tar catalytic cracking to obtain small molecular combustible gas and light bio-tar,

S3 making a biochar catalyst after preserving heat and ageing the biochar obtained from S1 at 530-650° C.

In the technical solutions according to the invention, the waste biomass from agriculture and forestry described in S1 can be various existing biomass that can be pyrolyzed and carbonized, and includes crop straw, rice husk or bits of wood. In a preferable technical solution according to the invention, the waste biomass from agriculture and forestry described in S1 is crop straw, more preferably corn straw.

In the technical solutions according to the invention, the raw materials described in S1 usually need being pre-processed such as being dried and shredded. In a preferable technical solution according to the invention, the pre-process is to dry the raw materials as far as its water content becomes 10˜15%, then shred and granulate them by a shredding and drying machine, and process them into particles with a size less than 5 cm.

In the technical solutions according to the invention, the pyrolysis carbonization reaction in S1 is carried out in a pyrolysis carbonization device (such as rotary pyrolysis carbonization furnace), and the bio-tar catalytic cracking reaction in S2 is carried out in a catalysis device, the same external heat source concurrently supplies heat so as to increase and maintain the temperature of the pyrolysis carbonization reaction and the bio-tar catalytic cracking reaction.

In a preferable technical solution according to the invention, in the continuous process after starting, the external heat source used to preserve the pyrolysis carbonization reaction temperature described in S1 and the bio-tar catalytic cracking reaction temperature described in S2 is the flue gas produced by combusting a part of the pyrolysis oil-gas mixture obtained in S1 and/or small molecular combustible gas and light bio-tar obtained in S2. The flue gas is refluxed to the pyrolysis carbonization device and the catalysis device without contact with the reacting materials, used to supply heat for the pyrolysis carbonization reaction and the bio-tar catalytic cracking reaction.

In a further preferable technical solution according to the invention, the catalysis device is placed inside the pyrolysis carbonization device, meanwhile, a flue gas channel isolated from the reacting materials is arranged inside the pyrolysis carbonization device, a part of the pyrolysis oil-gas mixture obtained in S1 and/or small molecular combustible gas and light bio-tar obtained in S2 is combusted, and the flue gas produced by the combustion is refluxed to the flue-gas channel inside the pyrolysis carbonization device, the waste heat of flue gas is used as an external heat source so as to concurrently supply heat for the pyrolysis carbonization reaction in S1 and the bio-tar catalytic cracking reaction in S2 by radiating heat through the flue-gas channel.

In a preferable technical solution according to the invention, the reflux of the flue gas is led through the flue-gas channel, so that the refluxed flue gas sequentially supplies heat for the bio-tar catalytic cracking reaction described in S2 and the pyrolysis carbonization reaction described in S1, so as to control the temperature of the above reactions, respectively. Therefore, the high-temperature flue gas can firstly supply heat for the bio-tar catalytic cracking reaction in higher reaction temperature, and then supply heat for the pyrolysis carbonization reaction in lower reaction temperature, so as to make full utilization of energy in the step way.

In the technical solutions according to the invention, the biochar catalyst described in S2 can be selected from various biochar catalysts available for the bio-tar catalytic cracking. In a preferable technical solution according to the invention, the biochar catalyst obtained in S3 is applied to S2 as a biochar catalyst for the bio-tar catalytic cracking.

In the technical solutions according to the invention, the method for making the aged biochar into a biochar catalyst described in S3 can be a variety of existing methods. In a preferable technical solutions according to the invention, the high-temperature torrefaction, immersing and loading nickel, magnetic stirring, and filtering and drying for the aged biochar, in particular includes the following steps: putting the biochar into a tube furnace, increasing the temperature to 850° C. by heating rate of 5° C/min, as the temperature is up, the specific surface area of the biochar rising, torrefaction the biochar at high temperature under nitrogen atmosphere for 2 h to obtain activated biochar; then loading the activated biochar with nickel by immersion method, using Ni(NO₃)₂·6H₂O as a precursor, a certain mass of which is weighed and dissolved in an appropriate amount of deionized water, adding the activated biochar to the above solution at 60° C. in magnetic stirring for 2 h; after finishing stirring, filtering and washing it with deionized water for 3 times, and drying it in an oven at 90° C. for 12 hours; finally, torrefaction the activated biochar in a tubular furnace at 500° C. in atmosphere of nitrogen for 2 hours and preserving heat for 2 hours to obtain a biochar catalyst, namely a nickel-based catalyst carried by the activated biochar.

The most preferred method of pyrolysis carbonization and catalysis for biomass, comprising the following steps:

a) using corn straw as raw material, the raw material is preprocessed into particles with a water content of 10˜15% and a size less than 5 cm;

b) feeding the particles obtained in a) into the pyrolysis carbonization device inside which a catalysis device is installed, for pyrolysis carbonization reaction at 630˜720° C., under sealing conditions, and making gas-solid separation of the products to obtain a bio-tar-containing pyrolysis oil-gas mixture and biochar;

c) sending the remaining part of the bio-tar-containing pyrolysis oil-gas mixture obtained in b) to the catalysis device inside the pyrolysis carbonization device, and treating it with a biochar catalyst at 690˜850° C. to perform bio-tar catalytic cracking to obtain small molecular combustible gas and light bio-tar;

d) combusting a part of the pyrolysis oil-gas mixture obtained in b) and/or the small molecular combustible gas and the light bio-tar obtained in c), refluxing the produced hot flue gas to the pyrolysis carbonization device without contact with the reacting materials, so as to supply heat for the pyrolysis carbonization reaction in b) and the bio-tar catalytic cracking reaction in c);

e) after preserving heat and ageing the biochar obtained from b) at 530˜650° C., putting the biochar into a tube furnace, increasing the temperature to 850° C. by heating rate of 5° C/min, as the temperature is up, the specific surface area of the biochar rising, torrefaction the biochar at high temperature under nitrogen atmosphere for 2 h to obtain activated biochar; then, adding the activated biochar into Ni(NO₃)₂·6H₂O and dissolving it in the solution of deionized water, stirring it for 2 h at 60° C.; and drying the product in an oven at 90° C. for 12 h after filtering it with deionized water; finally, torrefaction the product at 500° C. in nitrogen atmosphere for 2 hours and preserving heat for 2 hours to obtain a biochar catalyst, applying the obtained biochar catalyst into the catalysis device in c) as the biochar catalyst for bio-tar catalytic cracking.

The present invention also provides an integrated device used for the method of pyrolysis carbonization and catalysis for biomass, comprising: a spiral feeder, a pyrolysis carbonization device and a catalysis device, wherein the pyrolysis carbonization device includes a rotary pyrolysis carbonization furnace, a spiral plate conveying mechanism and a transmission system, the rotary pyrolysis carbonization furnace is provided with an inlet and an outlet, the spiral plate conveying mechanism is thoroughly installed inside the rotary pyrolysis carbonization furnace, used for actively conveying material, the transmission system is connected with the spiral plate conveying mechanism outside the rotary pyrolysis carbonization furnace through the driving parts used to drive the spiral plate conveying mechanism to operate by external power;

the spiral feeder is hermetically connected with the spiral plate conveying mechanism at the inlet end of the rotary pyrolysis carbonization furnace, and is used to feed material into the spiral plate conveying mechanism, which further conveys the material into the rotary pyrolysis carbonization furnace;

the catalysis device is arranged inside the rotary pyrolysis carbonization furnace, and is connected with the outlet of the rotary pyrolysis carbonization furnace as a whole through dynamic sealing, a biochar catalyst is loaded inside the catalysis device.

When the integrated device according to the invention is used in the method of pyrolysis carbonization and catalysis for biomass according to the invention, the detailed process is as follows: using waste biomass from agriculture as raw material, preprocessing the raw material, and passing the preprocessed raw material through the spiral feeder, the spiral plate conveying mechanism and the transmission system under sealing conditions to realize charge-in and uniform arrangement, the raw material taking pyrolysis reaction in the rotary pyrolysis carbonization furnace at 630˜720° C., and obtaining the pyrolysis oil-gas mixture and the biochar after pyrolysis and carbonization; the pyrolysis oil-gas mixture and the biochar entering the catalysis device integrated with the rotary pyrolysis carbonization furnace to realize carbon-gas separation, the pyrolysis oil-gas mixture going on a bio-tar catalysis process at 690˜850° C. in the catalysis device, the biochar catalyst in the catalysis device catalyzing and pyrolyzing the bio-tar particles in the pyrolysis oil-gas mixture into small molecular gases such as methane and hydrogen; at the same time, the biochar entering the catalysis device to be further aged at 530˜650° C., and part of the aged biochar is made into a new catalyst for continuing to use.

In a preferable integrated device of the invention, the rotary pyrolysis carbonization furnace is further provided with a flue-gas reflux device to utilize the waste heat of the flue gas from combustion. The flue-gas reflux device includes a flue-gas inlet arranged near the outlet of the rotary pyrolysis carbonization furnace, a flue-gas channel arranged along the inner wall of the rotary pyrolysis carbonization furnace, and a smoke vent arranged near the inlet of the rotary pyrolysis carbonization furnace. The flue-gas channel is used to lead the flue-gas reflux and isolate the flue gas from reacting materials. Part of the flue gas produced by the combustion of products such as the combustible gas and the separated bio-tar after catalytic cracking can be refluxed to the pyrolysis carbonization device through the flue-gas reflux device, and the waste heat of the refluxed flue-gas can be used to supply heat for the above process (i.e. catalytic cracking and pyrolysis carbonization) in the step way. After the flue gas produced by the combustion enters the rotary pyrolysis carbonization furnace through the flue-gas inlet, it forms a countercurrent flow with pyrolyzed material along the flue-gas channel, and flows out from the rotary pyrolysis carbonization furnace through the smoke vent. In this process, based on the leading of the flue gas channel, firstly, the refluxed flue gas passes through the catalysis device which is arranged in the rotary pyrolysis carbonization furnace and is connected with the outlet of the rotary pyrolysis carbonization furnace as a whole, meanwhile, flue gas being capable of serving as an external heat source to supply heat to the catalysis device so as to maintain a high temperature of bio-tar catalytic cracking, next the flue gas passes through other parts of the rotary pyrolysis carbonization furnace from the outlet to the inlet, during which the remaining heat can be supplied as an external heat source to the pyrolysis carbonization reaction in low temperature inside the rotary pyrolysis carbonization furnace.

In a preferable integrated device of the invention, a catalysis chamber is further included inside the catalysis device, and a biochar catalyst is loaded inside the catalysis chamber, and the top of the catalysis chamber is provided with a gas outlet communicating with the outside, and the lower part of the catalysis chamber is provided with a heat-preserving carbonization device communicating with the catalysis chamber, and the bottom of the heat-preserving carbonization device is provided with a carbon outlet. After the pyrolysis oil-gas mixture and biochar obtained by the pyrolysis carbonization enter the catalysis chamber, the bio-tar in the pyrolysis oil-gas mixture is decomposed into small molecular gases such as methane under the action of the biochar catalyst and heating, and the bio-tar takes catalytic cracking reaction, so that part of the heavy bio-tar is pyrolyzed into light bio-tar, and part of the bio-tar is converted into gas. In addition, CO₂, water vapor and other components in the pyrolysis oil-gas mixture take gasification reaction with biochar so as to convert into combustible components such as CO and H₂. All the gas flows out from the gas outlet on the top of the catalysis chamber to be collected and utilized. The biochar enters the heat-preserving carbonization device below the catalytic chamber, and preserves heat and ages so as to obtain a biochar carrier capable of making a biochar catalyst.

In a preferable technical solution according to the invention, the catalysis chamber carries the biochar catalyst by means of pull-out structure, that makes the replacement of the catalyst convenient and easy, and can ensure long-lasting catalytic effect.

In a preferable integrated device of the invention, the spiral plate conveying mechanism is installed on the inner wall of the rotary pyrolysis carbonization furnace, and is provided with a four-wire spiral plate for actively conveying material, it ensure that the filling coefficient of the material during the conveying process is 0.2 and the inclination of the spiral plate is set as 30˜60°.

In a preferable integrated device of the invention, a serpentine tube is further provided between the spiral feeder and the spiral plate conveying mechanism, a water seal for sealing is installed inside the serpentine tube, and is used as an explosion-proof device for emergent pressure relief when local deflagration or explosion occurs after a large quantity of air abnormally enters into the system.

Compared with the prior art, the beneficial effects of the invention are presented as follows:

1. The pyrolysis furnace and the catalysis device in the traditional pyrolysis device are connected with each other by dynamic sealing to form a whole body, concurrently supplied with heat by the waste heat of the refluxed flue gas, that effectively reduces heat loss and improves the overall thermal efficiency and catalytic efficiency, with cleanness and high-efficiency.

2. The pyrolyzed products such as biochar and pyrolysis gas are recycled and burned, and the produced high-temperature flue gas supplies heat for pyrolysis, which saves fuel costs with environmental protection and low-carbon.

3. The treated nickel-based biochar catalyst is used to effectively remove and transform the bio-tar in pyrolyzed original gas at high temperature. More pore structure and larger specific surface area of biochar provide more active sites for catalysis reaction, thereby promoting the catalytic conversion of bio-tar. The nickel-based biochar catalyst in the invention has high activity, good stability, low preparation cost, environmental protection, high-efficiency, long-lasting stability and good resistance to carbon-deposition. The catalyst is installed by means of pull-out structure, so the catalyst is easy to replace, which can ensure the long-lasting catalytic effect.

4. The designed processing capacity of the device and method according to the invention for biomass raw materials such as corn straw is 500 kg/h. The average detention time of material in the pyrolysis carbonization furnace is 30 minutes. The conveying mechanism adopts a four-wire spiral plate design. The bulk density of material is 120 kg/m³. The length of the reaction chamber is 8 m. The material-filling coefficient is 0.2.

### BRIEF DESCRIPTION OF THE DRAWINGS

FIG. 1 is a structure diagram of the integrated device for pyrolysis carbonization and catalysis in Example 1 of the invention.

FIG. 2 is a flow chart of the method of pyrolysis carbonization and catalysis described in Example 2 of the invention.

The reference signs are described as follows:

1—pyrolysis carbonization device; 11—rotary pyrolysis carbonization furnace; 111—spiral plate conveying mechanism; 112—combustor; 113—transmission system; 12—spiral feeder; 13—explosion-proof device; 14—dynamic sealing device; 15—catalysis chamber; 151—biochar catalyst; 152—catalyst-placing sieve plate; 153—pressure meter; 154—dust-deposition and heat-preserving carbonization device; 155—gas outlet; 157—carbon outlet; 2—a device for utilizing waste heat of refluxed flue gas; 21—flue-gas inlet; 22—flue-gas channel; 23—baffles; 24—heat-preserving layer; 25—smoke vent.

### DETAILED DESCRIPTION OF THE INVENTION

The invention will be further described in detail below in conjunction with the figures.

### EXAMPLE 1

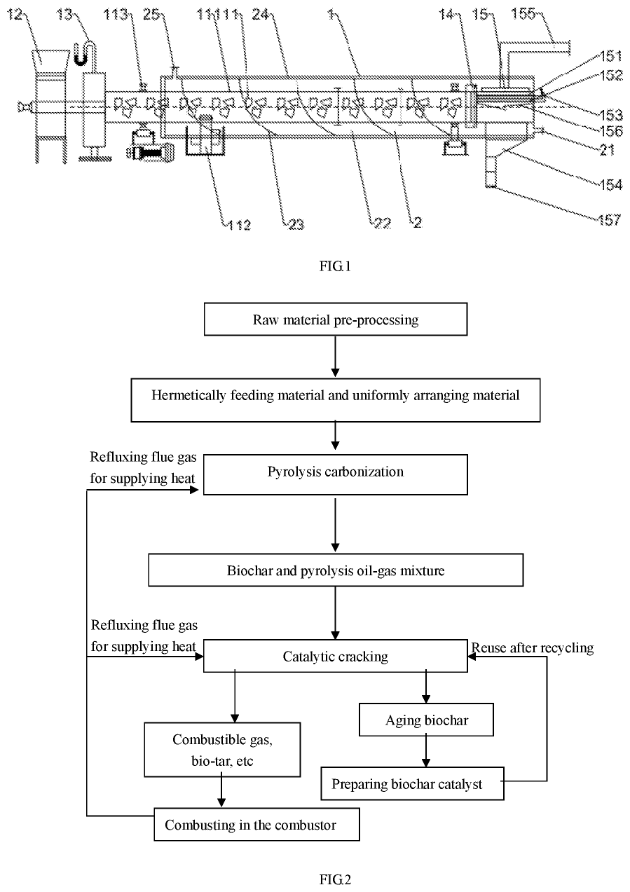

The integrated device for carbonization and catalysis according to the invention, as shown in FIG. 1, includes a spiral feeder 12, a pyrolysis carbonization device 1 and a catalysis device, wherein the pyrolysis carbonization device 1 includes a rotary pyrolysis carbonization furnace 11, a spiral plate conveying mechanism 111, and a transmission system 113, the catalysis device is located in the inner cavity of the pyrolysis carbonization device 1 and installed at the end of the rotary pyrolysis carbonization furnace 11 close to its outlet, the outlet end of the rotary pyrolysis carbonization furnace 11 is connected with the catalysis device as a whole. The spiral plate conveying mechanism 111 is provided inside the rotary pyrolysis carbonization furnace 11, which is heated by a combustor 112, and the rotary pyrolysis carbonization furnace 11 is connected to the transmission system 113.

The catalysis device includes a catalysis chamber 15, a pressure meter 153, a dust-deposition and heat-preserving carbonization device 154, and a gas outlet 155, wherein the catalysis chamber 15 is provided with the pressure meter 153, the dust-deposition and heat-preserving carbonization device 154 is provided on the bottom of the catalysis chamber 15, and a carbon outlet 157 is provided on the bottom of the dust-deposition and heat-preserving carbonization device.

A device for utilizing waste heat of refluxed flue gas 2 is provided between the rotary pyrolysis carbonization furnace 11 and the pyrolysis carbonization device 1. The device for utilizing waste heat of refluxed flue gas 2 includes a flue-gas inlet 21, a smoke vent 25, a flue-gas channel 22, baffles 23 and a heat-preserving layer 24, wherein the flue-gas inlet 21 is located at the outlet end of the pyrolysis carbonization device 1, and the smoke vent 25 is located at the inlet end of the pyrolysis carbonization device 1, the inflow direction of the flue gas is opposite to the direction of feeding material, the heat-preserving layer 24 is provided on the inner wall of the pyrolysis carbonization device 1, and the baffles 23 are also provided on the inner wall of the pyrolysis carbonization device 1, the baffles 23 are spirally located inside the flue-gas channel 22. The flue-gas channel 22 is isolated from the space where the spiral plate conveying mechanism 111 is located.

The spiral plate conveying mechanism 111 actively conveys material by four-wire spiral plates , which are processed into the shape of the spiral blades distributed along the spiral in single direction. They are divided into four spiral lines, and the pitch of the plate is selected as 500 mm, the height as 500 mm and the thickness as 10 mm, according to the size of the rotary drum. The blades are interlaced with each other by 90 degrees, and the four blades are evenly distributed on the entire inner surface of the reactor by 360 degrees to ensure that the material is conveyed at a uniform speed and the filling coefficient of the material during the conveying process is 0.2. The inclination of the spiral plate is set as 30˜60°.

The spiral plate not only has the ability of spirally pushing and conveying material, but also can turn over the material, so that the material is uniformly heated during being pushed forward as a whole, that improves the stability and order of material transportation, and can balance the heat exchange efficiency and the uniform carbonization for the system. One end of the spiral plate conveying mechanism is further provided with a support frame, where a transmission mechanism is installed. The transmission mechanism is a motor and one of a gear, a sprocket or a belt connecting the motor to the spiral plate conveying mechanism.

The feeding process of the spiral feeder 12 is stable, without spiral blockage, so it can transport materials with a larger particle size and is suitable for short-distance transportation.

An explosion-proof device 13 is provided at one end of the spiral plate conveying mechanism 111. The explosion-proof device 13 is a serpentine tube inside which a water seal for sealing is arranged. The explosion-proof device 13 adopts a U-shaped water seal, which is used for emergent pressure relief when local deflagration or explosion occurs after a large quantity of air abnormally enters into the system.

The combustor 112 is composed of a fuel unit and a gas unit. The fuel oil unit is connected with the outlet of the rotary pyrolysis carbonization furnace 11 and the flue-gas inlet 21 of the device for utilizing waste heat of refluxed flue gas 2 by pipes, respectively, and is used to combust part of the pyrolysis gas produced by pyrolysis carbonization, and then transport the produced flue gas to the device for utilizing waste heat of refluxed flue gas 2. The gas unit is connected with the gas outlet 155 of the catalysis device and the flue-gas inlet 21 of the device for utilizing waste heat of refluxed flue gas 2 by pipes, respectively, and is used to combust the combustible gas produced by catalytic cracking, and then transport the produced flue gas to the device for utilizing waste heat of refluxed flue gas 2.

The dynamic sealing device 14 connects the outlet end of the rotary pyrolysis carbonization furnace 11 and the fixed catalysis chamber 15 into a whole body.

A biochar catalyst 151 is placed on a catalyst-placing sieve plate 152 with pull-out structure inside the catalysis chamber 15, and the gas outlet 155 controls the detention time of the pyrolysis gas in gaseous phase inside the catalysis chamber to be 0.5˜1.0 s by the control method to adjust the gas flow.

In the device for utilizing waste heat of refluxed flue gas 2, the hot flue-gas flows in the flue-gas inlet 21, and passes through the entire chamber in whirling flow via the baffle 23, then is discharged from the flue gas outlet 25, which prolongs the heat exchange time and enhances the heat exchange effect of the reaction chamber.

The pyrolysis gas originally produced by the rotary pyrolysis carbonization furnace 11 is first catalyzed via the catalysis chamber 15, and then purified, dedusted and separated with oil from water to obtain pyrolytic by-products. The pyrolytic by-products mainly include combustible gas, bio-tar, wood vinegar, etc. The external heat source used by the rotary pyrolysis carbonization furnace 11 is provided by the refluxed flue gas produced by the combustion of bio-tar and part of the pyrolysis gas, or after part of the pyrolysis gas originally produced is branched off and directly combusted, the produced flue gas is refluxed for heating.

The specific operation process is as follows. Biomass raw materials such as straw enter from the hopper of the spiral feeder 12, and the electric motor uniformly pushes the raw materials in the hopper into the rotary pyrolysis carbonization furnace 11. The materials in the rotary pyrolysis carbonization furnace 11 are turned over and move forward under the action of the spiral plate conveying mechanism 111, meanwhile, they are heated and decomposed under the action of the heat source or the waste heat of the refluxed flue gas, and undergo dewatering and pyrolyzing, then the pyrolysis gas is separated from the biochar after entering the catalytic chamber 15. The biochar is thermally decomposed under the action of heating, and then enters the dust-deposition and heat-preserving carbonization device 154 below the catalysis chamber 15, and is further aged in an oxygen-and-thermal insulation environment. Part of the aged biochar is made into a new biochar catalyst to continue to be used after the processes such as high-temperature torrefaction, immersing and loading nickel, magnetic stirring, and filtering and drying.

At the same time, the pyrolysis gas originally produced by the rotary pyrolysis carbonization furnace 11 flows upward from the bottom of the catalysis chamber 15. After passing through the dust baffle, the bio-tar in the pyrolysis gas is decomposed into small molecular gases such as methane under the combined action of the biochar catalyst and the waste heat of the refluxed flue gas. The bio-tar undergoes a catalytic cracking reaction, so that part of the heavy bio-tar is pyrolyzed into light bio-tar, and part of the bio-tar is converted into gas. In addition, the CO₂, water vapor and other components in the pyrolysis gas undergo a gasification reaction with biochar, then are converted into combustible components such as CO and H₂, finally flow out from the upper gas outlet 155 together with other gases for collection.

### EXAMPLE 2

A method of pyrolysis carbonization and catalysis for biomass shown as FIG. 2 includes the following steps:

Biomass such as corn straw is used as raw material. The corn straw is shredded into small particles with a particle size of 1˜5 cm, dried at 70° C.˜120° C. to the extent that the water content is 10%˜15%, then shredded and granulated by a shredding and drying machine, and processed into particles with a size less than 5 cm.

The processed raw materials are fed and uniformly distributed through the spiral feeder 12, the spiral plate conveying mechanism 111 and the transmission system 113 under sealing conditions, using the integrated device described in Example 1. In the rotary pyrolysis carbonization furnace 11, a pyrolysis reaction is performed at 720° C., and the pyrolysis oil-gas mixture and biochar are obtained after pyrolysis carbonization. The pyrolysis oil-gas mixture and biochar enter the catalysis chamber 15 integrated with the rotary pyrolysis carbonization furnace 11 to carry out the catalytic cracking process for bio-tar, and achieve carbon-gas separation. The biochar catalyst 151 in the catalysis chamber 15 catalyzes and pyrolyzes the bio-tar particles in the pyrolysis oil-gas mixture into small molecular gases such as methane and hydrogen under at the temperature more than 690° C. A pressure meter 153 is installed in the catalysis chamber 15 with an alarm function for excessive pressure. At the same time, the biochar enters the dust-deposition and heat-preserving carbonization device 154 below the catalysis chamber 15 to be further aged, and the environmental temperature of the heat-preserving carbonization process is controlled at 650° C. to obtain aged corn straw biochar.

The aged corn straw biochar is taken out from the carbon outlet 157 and put into a tube furnace, where the temperature is increased to 850° C. by heating rate of 5° C/min. As the temperature is up, the specific surface area of the corn straw biochar can rise to 79.81 m²/g.

Then, it is baked at high temperature under nitrogen atmosphere for 2 h to obtain activated biochar.

Then the activated biochar carries nickel by immersion method, Ni(NO₃)₂·6H₂O is used as a precursor, a certain mass of which is weighed and dissolved in an appropriate amount of deionized water. The activated biochar is added to the above solution at 60° C. in magnetic stirring for 2 h. After finishing stirring, it is filtered and washed with deionized water for 3 times, and dried in an oven at 90° C. for 12 hours. Finally, the activated biochar is baked in a tubular furnace at 500° C. for 2 hours and preserved with heat for 2 hours under nitrogen atmosphere, then a nickel-based catalyst carried by the activated corn straw biochar is obtained.

During the above process, part of the combustible gas inside the catalysis chamber 15 after catalytic cracking is discharged through the gas outlet 155 at the top of the catalysis chamber 15. A mixture of combustible gas and bio-tar liquid obtained after cooling is then sent to the combustor 112 for combustion where flue gas is produced, then the flue gas is refluxed into the device for utilizing waste heat of refluxed flue gas 2. After the refluxed flue gas enters from the flue-gas inlet 21, it flows along the flue-gas channel 22 around the periphery of the rotary pyrolysis carbonization furnace 11, and forms a swirling flow via the baffle 23, which first supplies heat for the catalytic cracking reaction in the catalysis chamber 15, and next supplies remaining heat for the pyrolysis carbonization reaction, thereby using the waste heat of the refluxed flue gas to supply heat for the above process in the step way. That prolongs the heat exchange time and enhances the heat exchange effect of the reaction chamber.

Compared with biochar from rice husk and wood charcoal, the corn straw biochar obtained in this example has relatively higher K and Ca content, which is beneficial to improve the catalyst activity.

### EXAMPLE 3

A method of pyrolysis carbonization and catalysis for biomass, the overall steps and the used device of which are basically the same with those in Example 2. The difference is that the pyrolysis reaction temperature is 700° C., the temperature for heat-preserving carbonization is 600° C., and the temperature for bio-tarcatalytic cracking is 800° C.

### EXAMPLE 4

A method of pyrolysis carbonization and catalysis for biomass, the overall steps and the used device of which are basically the same with those in Example 2. The difference is that the pyrolysis reaction temperature is 630° C., the temperature for heat-preserving carbonization is 530° C., and the temperature for bio-tarcatalytic cracking is 690° C.

The pyrolysis carbonization temperature of the system according to the invention is controlled at 630˜720° C., and the bio-tar content in the original pyrolysis gas produced by the carbonization is 15%˜20%. The nickel-loaded content of nickel-based biochar catalyst made according to the invention is 1.5%. The reaction time of bio-tar reaches 20 min at 750˜850° C., and the carbon conversion rate of bio-tar can reach 78.5% at 1.06 g/m³, and the pyrolysis rate of bio-tar can reach more than 80% in a short time.

The invention can keep the optimum pyrolytic temperature of the biomass at 600° C., while maintaining the catalytic temperature of the biochar at 700° C. or above, so as to perform a function of removing bio-tar, and realize the gradient distribution of the optimum reaction temperature for biomass pyrolysis, bio-tar removal and catalyst regeneration. Among them, the temperature of the catalysis chamber can reach up to 850° C. with capability to meet the needs of catalysis reaction, high thermal efficiency, high bio-tar decomposition rate, and bio-tar conversion rate more than 80%.

1. A method of pyrolysis carbonization and catalysis for biomass, which comprises the following steps:
S1 using corn straw as raw material, conducting pyrolysis carbonization reaction at 630˜720° C. under sealing conditions obtaining a bio-tar-containing pyrolysis oil-gas mixture and biochar after gas-solid separation of the products,
S2 treating the bio-tar-containing pyrolysis oil-gas mixture obtained from S1 with a biochar catalyst at 690˜850° C., carrying out bio-tar catalytic cracking to obtain small molecular combustible gas and light bio-tar,
S3 preserving heat and ageing the biochar obtained from S1 at 530˜650° C., then making a biochar catalyst.

2. (canceled)

3. The method according to claim 1, wherein the raw material in S1 is pre-processed, the pre-process is to dry the raw material as far as its water content becomes 10˜15%, then shred and granulate it by a shredding and drying machine, and process it into particles with a size less than 5 cm.

4. The method according to claim 1, wherein the pyrolysis carbonization reaction in S1 is carried out in a pyrolysis carbonization device, and the bio-tar catalytic cracking in S2 is carried out in a catalysis device; a same external heat source concurrently supplies heat to the pyrolysis carbonization device and the catalysis device, so as to increase and maintain the temperature of the pyrolysis carbonization reaction and the bio-tar catalytic cracking; the external heat source is a flue gas produced by combusting a part of the pyrolysis oil-gas mixture obtained in Si and/or small molecular combustible gas and light bio-tar obtained in S2; the flue gas is refluxed to the pyrolysis carbonization device and the catalysis device without contact with the reacting material, supplying heat for the pyrolysis carbonization reaction and the bio-tar catalytic cracking reaction.

5. The method according to claim 3, wherein the catalysis device is placed inside the pyrolysis carbonization device, meanwhile, a flue gas channel isolated from the reacting material is arranged inside the pyrolysis carbonization device, a part of the pyrolysis oil-gas mixture obtained in Si and/or small molecular combustible gas and light bio-tar obtained in S2 is combusted, and the flue gas produced by the combustion is refluxed to the flue-gas channel inside the pyrolysis carbonization device, the waste heat of the flue gas is used as the external heat source, supplying heat concurrently for the pyrolysis carbonization reaction in S1 and the bio-tar catalytic cracking reaction in S2 by radiating heat through the flue-gas channel.

6. The method according to claim 4, wherein the reflux of the flue gas is led through the flue-gas channel, so that the refluxed flue gas sequentially supplies heat for the bio-tar catalytic cracking in S2 and the pyrolysis carbonization reaction in S1.

7. The method according to claim 1, wherein the biochar catalyst obtained in S3 is applied to S2 as a biochar catalyst for the bio-tar catalytic cracking.

8. The method according to claim 1, wherein the method for making a biochar catalyst with the aged biochar in S3 comprises high-temperature torrefaction, immersing and loading nickel, magnetic stirring, and filtering and drying for the aged biochar; in particular includes the following steps: putting the aged biochar into a tube furnace, increasing the temperature to 850° C. at the heating rate of 5° C/min, as the temperature is up, the specific surface area of the biochar increased as well, torrefying the biochar at high temperature under nitrogen atmosphere for 2 h to obtain activated biochar; then loading the activated biochar with nickel by immersion method, using Ni(NO₃)₂·6H₂O as a precursor, a certain mass of which is weighed and dissolved in an appropriate amount of deionized water, adding the activated biochar to the above solution at 60° C. in magnetic stirring for 2 h; after finishing stirring, filtering and washing it with deionized water for 3 times, and drying it in an oven at 90° C. for 12 hours; finally, torrefaction the activated biochar in a tubular furnace at 500° C. in atmosphere of nitrogen for 2 hours and preserving heat for 2 h to obtain a biochar catalyst, namely a nickel-based catalyst carried by the activated biochar.

9. An integrated method of pyrolysis carbonization and catalysis for biomass, comprising the following steps:
a) using corn straw as raw material, the raw material is preprocessed into particles with a water content at the range of 10˜15% and a size less than 5 cm;
b) feeding the particles obtained in a) into the pyrolysis carbonization device inside which a catalysis device is installed, for pyrolysis carbonization reaction at 630˜720° C., under sealing conditions, and making gas-solid separation of the products to obtain a bio-tar-containing pyrolysis oil-gas mixture and biochar;
c) sending the remaining part of the bio-tar-containing pyrolysis oil-gas mixture obtained in b) to the catalysis device inside the pyrolysis carbonization device, and treating it with a biochar catalyst at 690˜850° C. to perform bio-tar catalytic cracking to obtain small molecular combustible gas and light bio-tar;
d) combusting a part of the pyrolysis oil-gas mixture obtained in b) and/or the small molecular combustible gas and the light bio-tar obtained in c), refluxing the produced hot flue gas to the pyrolysis carbonization device without contact with the reacting material, so as to supply heat for the pyrolysis carbonization reaction in b) and the bio-tar catalytic cracking reaction in c);
e) after preserving heat and ageing the biochar obtained from b) at 530˜650° C., putting the biochar into a tube furnace, increasing the temperature to 850° C. at the heating rate of 5° C/min, as the temperature is up, the specific surface area of the biochar increased as well, torrefying the biochar at high temperature under nitrogen atmosphere for 2h to obtain activated biochar; then, adding the activated biochar into Ni(NO₃)₂·6H₂O and dissolving it in the solution of deionized water, stirring it for 2 h at 60° C.; and drying the product in an oven at 90° C. for 12 h after filtering it with deionized water; finally, torrefying the product at 500° C. in nitrogen atmosphere for 2 h and preserving heat for 2 h to obtain a biochar catalyst, applying the obtained biochar catalyst into the catalysis device in c) as the biochar catalyst for bio-tar catalytic cracking.

10. An integrated device used for a method of pyrolysis carbonization and catalysis for biomass, comprising: a spiral feeder, a pyrolysis carbonization device and a catalysis device,
wherein the pyrolysis carbonization device includes a rotary pyrolysis carbonization furnace, a spiral plate conveying mechanism and a transmission system, the rotary pyrolysis carbonization furnace is provided with an inlet and an outlet, the spiral plate conveying mechanism is thoroughly installed inside the rotary pyrolysis carbonization furnace, used for actively conveying material, the transmission system is connected with the spiral plate conveying mechanism outside the rotary pyrolysis carbonization furnace through the driving parts used to drive the spiral plate conveying mechanism to operate by external power;
the spiral feeder is hermetically connected with the spiral plate conveying mechanism at the inlet end of the rotary pyrolysis carbonization furnace, which is used to feed material into the spiral plate conveying mechanism, and further conveys the material into the rotary pyrolysis carbonization furnace;
the catalysis device is arranged inside the rotary pyrolysis carbonization furnace, which is connected with the outlet of the rotary pyrolysis carbonization furnace to form an integrated body through dynamic sealing, a biochar catalyst is loaded inside the catalysis device.

11. The integrated device according to claim 10, wherein the rotary pyrolysis carbonization furnace is further provided with a flue-gas reflux device to utilize the waste heat of the combusted flue gas, the flue-gas reflux device includes a flue-gas inlet arranged near the outlet of the rotary pyrolysis carbonization furnace, a flue-gas channel arranged along the inner wall of the rotary pyrolysis carbonization furnace, and a smoke vent arranged near the inlet of the rotary pyrolysis carbonization furnace, and the flue-gas channel is used to lead the reflux of flue gas and isolate the flue gas from reacting material.

12. The integrated device according to claim 10, wherein a catalysis chamber is further included inside the catalysis device, and biochar catalyst is loaded inside the catalysis chamber, and the top of the catalysis chamber is provided with a gas outlet communicating with the outside, and the lower part of the catalysis chamber is provided with a heat-preserving carbonization device communicating with the catalysis chamber, and the bottom of the heat-preserving carbonization device is provided with a carbon outlet.

13. The integrated device according to claim 12, wherein the catalysis chamber carries the biochar catalyst by means of pull-out structure.

14. The integrated device according to claim 9, wherein the spiral plate conveying mechanism is installed on the inner wall of the rotary pyrolysis carbonization furnace, which provided with a four-wire spiral plate for actively conveying material, it ensure that the filling coefficient of the material during the conveying process is 0.2, and the inclination of the spiral plate is set at the range of 30-60°.

15. The integrated device according to claim 10, wherein a serpentine tube is further provided between the spiral feeder and the spiral plate conveying mechanism, a water seal for sealing is installed inside the serpentine tube, which used as an explosion-proof device for emergent pressure relief when local deflagration or explosion occurs after a large quantity of air abnormally enters into the system.
